(19) United States
(12) Patent Application Publication
(10) Pub. No.: US 2008/0184090 A1
(43) Pub. Date: Jul. 31, 2008

(54) STORAGE APPARATUS

(76) Inventor: Tadaaki KINOSHITA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/962,496

(22) Filed: Dec. 21, 2007

(30) Foreign Application Priority Data
Dec. 22, 2006 (JP) P2006-346284

(51) Int. Cl. G06F 11/00

(52) U.S. Cl. 714/758; 714/E11.007

(57) ABSTRACT

According to one embodiment, a storage apparatus includes: a data transmission unit capable of transmitting data to a host apparatus in a data format in which a content to be transmitted to the host apparatus is accompanied by a CRC; a storage medium in which the content is stored; an error detection unit capable of detecting a reading error occurring in a processing in which the content is read from the storage medium; and an error information recording unit making the error information detected by the error detection unit be stored in an error information storage part. Further, the storage apparatus includes a CRC selection unit capable of selecting, based on the error information, whether to create a normal CRC or to intentionally create a mismatching CRC to make the host apparatus detect a CRC error in creating the CRC concerning the content.

### CROSS-REFERENCE TO RELATED APPLICATIONS

This application is based upon and claims the benefit of priority from Japanese Patent Application No. 2006-346284, filed Dec. 22, 2006, the entire contents of which are incorporated herein by reference.

### BACKGROUND

1. Field

One embodiment of the invention relates to a storage apparatus transmitting data to a host apparatus.

2. Description of the Related Art

Conventionally, as a technology of such a field, there is known a storage apparatus described in Japanese Patent Application Publication (KOKAI) No. 2006-139556 (Patent Document 1). A host interface section of the storage apparatus described in this document performs a reception of a command, a transmission of a decode and a response, and a transmission/reception of data to/from the host apparatus. A read/write control section of the storage apparatus performs writing or reading of data to/from a memory in accordance with a decode result of the command. In this storage apparatus, an error generated in writing/reading of the data by the read/write control section is detected by an error detection section. In order to notify the host apparatus of the above-described detected error, an interrupt signal to the host apparatus is outputted.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a magnetic disk apparatus as an embodiment of a storage apparatus according to the invention;

FIG. 2 is an exemplary diagram showing an example of a data packet transmitted by the magnetic disk apparatus of FIG. 1 in the embodiment;

FIG. 3 is an exemplary block diagram showing a detail of a data transfer control section of the magnetic disk apparatus of FIG. 1 in the embodiment;

FIG. 4 is an exemplary block diagram showing a detail of a data packet control section of the magnetic disk apparatus of FIG. 1 in the embodiment;

FIG. 5 is an exemplary chart showing an example of a command reception control flow in a case that the magnetic disk apparatus performs a data transfer by a reception of a data read command in the embodiment;

FIG. 6 is an exemplary chart showing an example of a command reception control flow in a case that the magnetic disk apparatus performs a transfer of error information by a reception of an error information read command in the embodiment;

FIG. 7 is an exemplary chart showing an example of a command transmission control flow of a host apparatus at a time of performing a data transfer in the embodiment; and

FIG. 8 is an exemplary block diagram showing a storage apparatus using a nonvolatile memory as another embodiment of the storage apparatus according to the invention.

### DETAILED DESCRIPTION

Various embodiments according to the invention will be described hereinafter with reference to the accompanying drawings. In general, according to one embodiment of the invention, a storage apparatus includes: a data transmission unit capable of transmitting data to a host apparatus in a data format in which a content to be transmitted to the host apparatus is accompanied by a CRC(Cyclic Redundancy Check); a storage medium in which the content is stored; an error detection unit capable of detecting a reading error occurring in a processing in which the content is read from the storage medium; and an error information recording unit making the error information detected by the error detection unit be stored in an error information storage part. Further, the storage apparatus includes a CRC selection unit capable of selecting, based on the error information, whether to create a normal CRC or to intentionally create a mismatching CRC to make the host apparatus detect a CRC error in creating the CRC concerning the content.

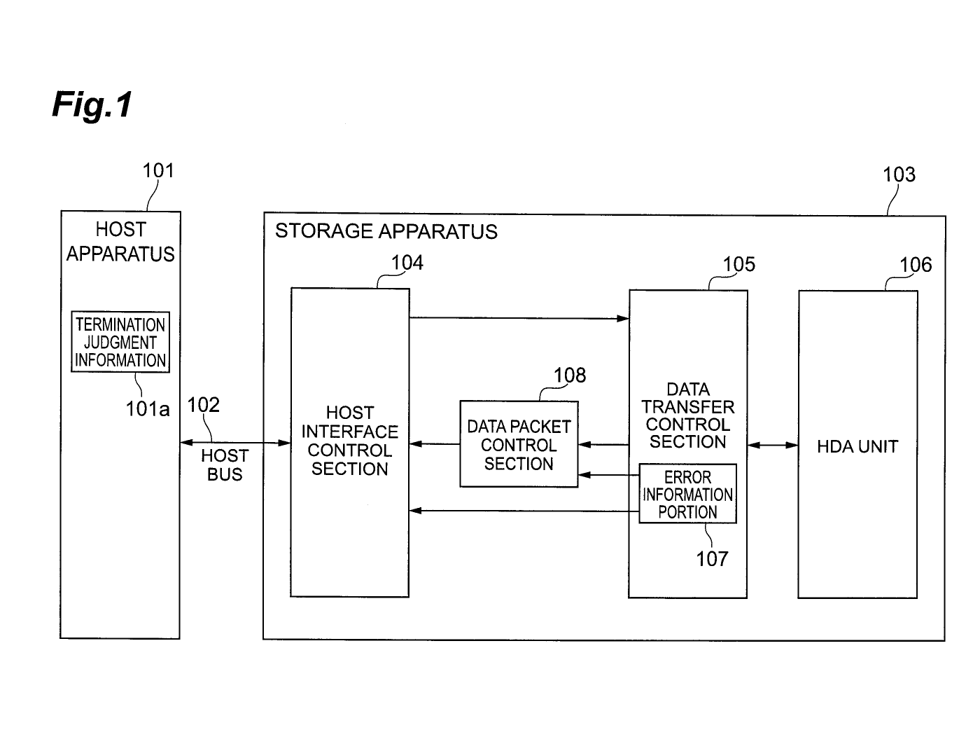

As shown in FIG. 1, a magnetic disk apparatus (storage apparatus) 103 is connected to a host apparatus 101 via a host bus 102 and performs a data transfer to/from the host apparatus 101. For example, an electronic apparatus represented by a personal computer, a portable terminal, a cellular phone or the like is applied to the host apparatus 101. The magnetic disk apparatus 103 is used as a storage apparatus for such an electric apparatus and is also called a hard disk apparatus. A data transfer method between the host apparatus 101 and the magnetic disk apparatus 103 is not limited in particular, and hereinafter an example of using a packet method will be described.

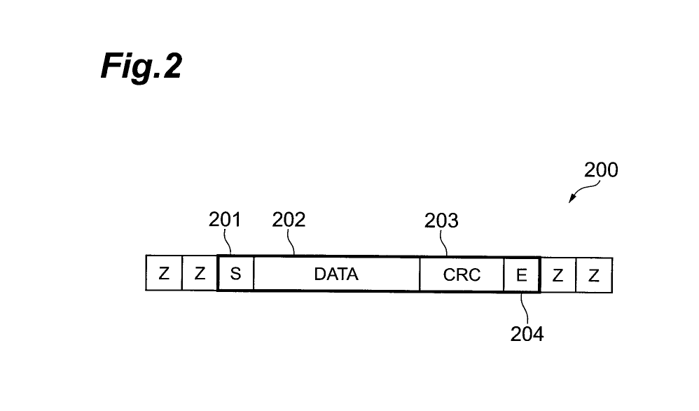

The host apparatus 101 issues a data read command including an arbitrary data address and data length to the magnetic disk apparatus 103 so as to request for a data transfer. In response to this data read command, the magnetic disk apparatus 103 transfers content data related to the request to the host apparatus 101 as a data packet 200 (see FIG. 2). An example of a layout of the data packet 200 is shown in FIG. 2. This data packet 200 is constituted with, from a head, a start bit 201, content data 202, CRC data 203 concerning the content data, and an end bit 204.

Reference signals Z in FIG. 2 indicate high impedance parts before and after the data packet 200. When an error information read command is issued from the host apparatus 101, the magnetic disk apparatus 103 transfers error information stored in an error information portion 107 to the host apparatus 101, a detail being described later.

The magnetic disk apparatus 103 includes a host interface control section 104, a data transfer control section 105 including the error information portion 107, a hard disk assembling unit (hereinafter, referred to as an “HDA unit”) 106, and a data packet control section 108. The host interface control section 104 is constituted with an interface circuit connected to an interface section of a host apparatus 101 side by a serial interface, for example.

The HDA unit 106 includes mainly a mechanism part of the magnetic disk apparatus 103. In other words, the HDA unit 106 includes a magnetic disk for magnetically recording the content data together with ECC (Error Correcting Code) information, a magnetic head which performs reading/writing of data from/to the magnetic disk, and an actuator supporting the magnetic head in a movable manner in a radial direction of the magnetic disk, detailed illustration being omitted. Further, the HDA unit 106 includes a spindle motor rotating the above-described magnetic disk and a voice coil motor being a drive source of the above-described actuator.

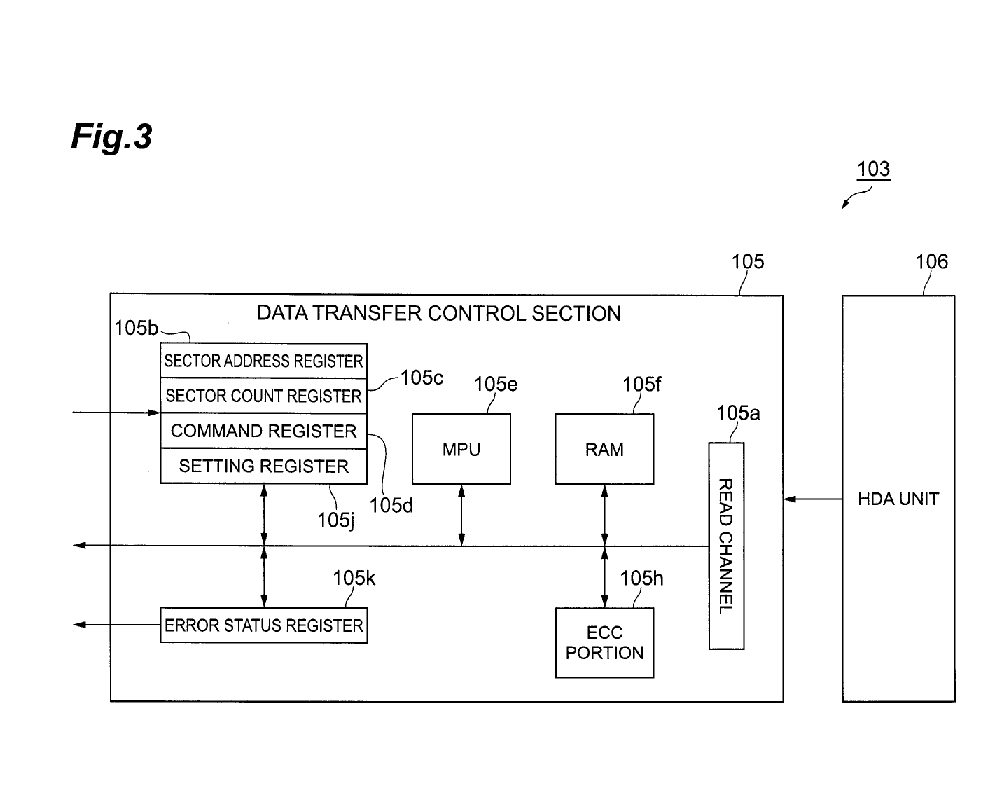

As shown in FIG. 3, the data transfer control section 105 includes a read channel 105a, each register 105b, 105c, 105d, 105j storing an order from the host apparatus 101, an MPU 105e performing a data transfer processing in correspondence with the order from the host apparatus 101, and a RAM 105f. The read channel 105a is a signal processing device and performs various signal processings including analog/digital conversion of a read signal read from the HDA unit 106 and decoding of the read data.

The sector address register 105b holds a head sector to become a target of reading, the sector count register 105c holds a sector number of data to read, and the command register 105d holds a command from the host apparatus 101. The setting register 105j holds information for setting an operation based on an order from the host apparatus 101. For example, in the setting register 105j is held a setting and the like of whether to continue or to terminate the data transfer in a case that an error occurs during the data transfer. The RAM 105f temporarily holds content data after being read from the HDA unit 106 and ECC processed, or stores a data transfer control program.

Further, the data transfer control section 105 includes an ECC portion 105h which checks an ECC of the content data from the HDA unit 106 and detects a success or an error of reading, and an error status register 105k. This error status register 105k stores the error information when the ECC portion 105h cannot correct the error of the data or cannot read the data. In other words, the error status register 105k functions as the above-described error information portion 107.

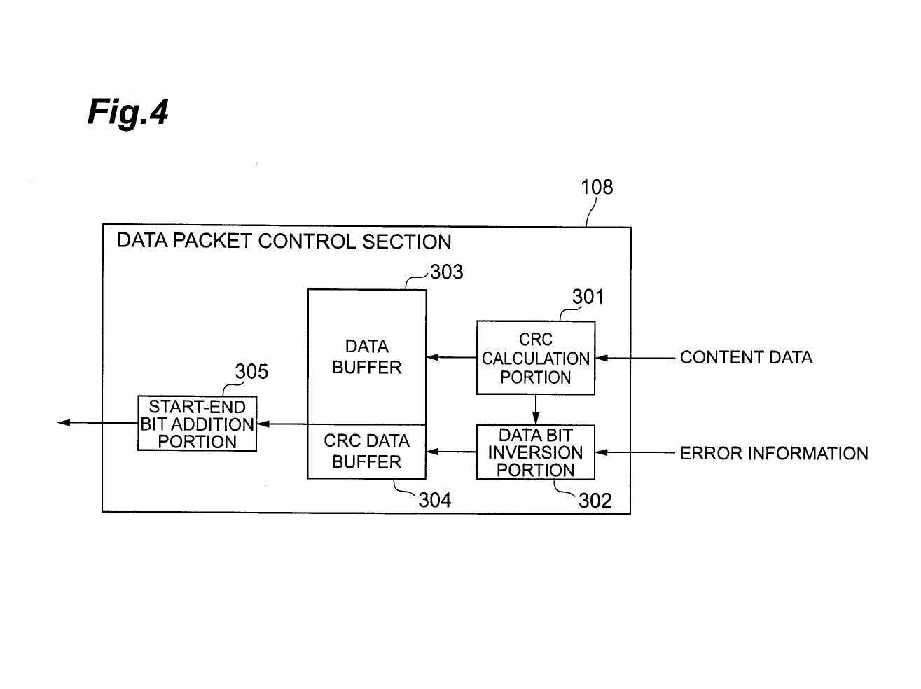

As shown in FIG. 4, the data packet control section 108 includes a CRC calculation portion 301, a data bit inversion portion 302, a data buffer 303, a CRC data buffer 304, and a Start-End bit addition portion 305. The data packet control section 108 receives into the data buffer 303 the content data from the above-described data transfer control section 105 while calculating a CRC value in the CRC by the CRC calculation portion 301.

The calculated CRC value is stored in the CRC data buffer 304 via the data bit inversion portion 302. At this time, in the data bit inversion portion 302, either a processing of performing a bit inversion of the above-described CRC value or a processing of not performing the bit inversion is selected based on the error information of the above-described error information portion 107, and then carried out.

More specifically, if error information indicating an occurrence of a “reading error” exists in the error information portion 107, the data bit inversion portion 302 performs the bit inversion processing of the CRC value and makes the CRC data buffer 304 store a bit-inversed CRC value. In this case, since the data packet 200 to be eventually transferred to the host apparatus 101 is mismatched in the CRC, the CRC error occurs in the host apparatus 101.

In other words, by such a processing of the data bit inversion portion 302, a data packet 200 with a mismatching CRC is intentionally created and transferred to the host apparatus 101. On the other hand, if the error information indicating the occurrence of the “reading error” does not exist in the error information portion 107, the data bit inversion portion 302 does not perform the bit inversion processing of the CRC value and makes the CRC data buffer 304 store the CRC value. In this case, the data packet 200 to be eventually transferred to the host apparatus 101 is matched in the CRC, and the transferred data packet 200 is processed normally by the host apparatus 101.

The Start-End bit addition portion 305 adds predetermined start bit 201 and end bit 204 to before and after the data 202, 203 stored in the data buffer 303 and the CRC data buffer 304 as stated above, whereby the data packet 200 (see FIG. 2) is formed. The data packet 200 formed as above is transferred from the data packet control section 108 to the host apparatus 101 via the host interface control section 104.

Next, the data transfer between the above-described magnetic disk apparatus 103 and host apparatus 101 will be described.

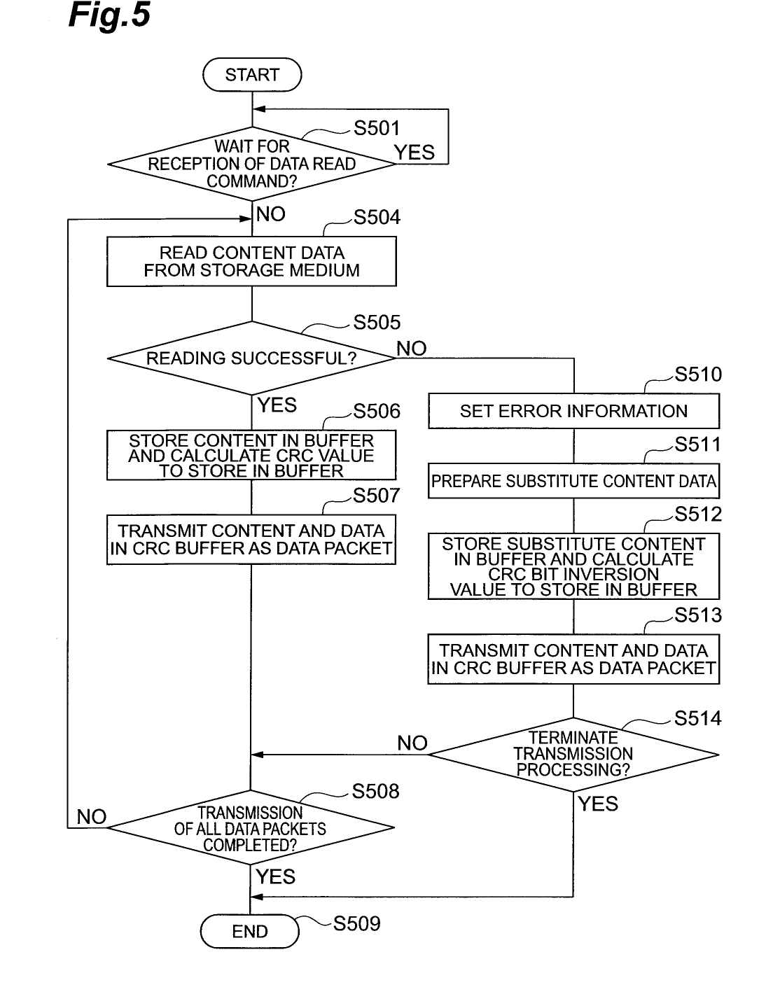

First, a processing in which the magnetic disk apparatus 103 forms the data packet 200 in correspondence with the data read command and transmit the data packet 200 will be described with reference to FIG. 5 and FIG. 1.

The host interface control section 104 of the magnetic disk apparatus 103 receives the data read command from the host apparatus 101, in a command receiving state (S501). The data transfer control section 105 reads content data (data appropriate for constituting the data packet 200) of an appropriate size from an appropriate address for the HDA unit 106 in correspondence with a content of the data read command from the host interface control section 104 (S504).

If reading is successful in the above reading processing and is not judged to be an error (S505), the read content data 202 is transmitted to the data packet control section 108. In the data packet control section 108, the content data 202 from the data transfer control section 105 is stored in the data buffer 303 (S506), and the CRC data 203 is created based on the content data 202 and the error information of the error information portion 107.

In this case, since the error information indicating the occurrence of the “reading error” is not stored in the error information portion 107, the CRC calculation value concerning the content data 202 is stored in the CRC data buffer 304 without being subjected to the bit inversion processing by the above-described data bit inversion portion 302 (S506). As stated above, from the data packet control section 108, the content data 202 and the normal CRC data 203 concerning the content data 202 are transmitted to the Start-End bit addition portion 305.

Subsequently, after addition processings of the start bit 201 and the end bit 204 by the Start-End bit addition portion 305, the data packet 200 having the normal CRC value is created and transmitted to the host apparatus 101 via the host interface control section 104 (S507). Subsequently, the data transfer control section 105 judges whether or not all the data packets 200 for the data included at a time of the above-described data read command are transmitted (S508). If the judgment is Yes, the processings are terminated (S509), and if the judgment is No, processings for the subsequent data packet 200 are repeated from S504.

On the other hand, if it is judged to be a reading error (S505) due to any abnormality in the reading processing of S504, the error information indicating the occurrence of the “reading error” is stored in the error information portion 107 (S510). Then, the data transfer control section 105 prepares any substitute data (S511) and transmits the substitute data to the data packet control section 108. For the above-described substitute data, there can be used data of any address on the HDA unit 106 with which the reading error does not occur, for example, and so forth.

Next, in the data packet control section 108, the above-described substitute data from the data transfer control section 105 is stored in the data buffer 303 as the content data 202, and based on this content data 202 and the error information of the error information portion 107, the CRC data 203 is created. In this case, since the error information indicating the occurrence of the “reading error” is already stored in the error information portion 107 in above-described S510, the CRC calculation value concerning the content data 202 is subjected to the bit inversion processing by the data bit inversion portion 302 and stored in the CRC data buffer 304 (S512).

As stated above, in the data packet control section 108, the content data 202 and the CRC data 203 which are intentionally made mismatching in the CRC are transmitted to the Start-End bit addition portion 305. Subsequently, after the addition processings of the start bit 201 and the end bit 204 by the Star-End bit addition portion 305, the data packet 200 is created and transmitted to the host apparatus 101 via the host interface control section 104 (S513). Incidentally, since this data packet 200 is mismatching in the CRC, the data packet 200 makes the host apparatus 101 which receives the data packet 200 detect the CRC error as will be described later.

Next, if the “reading error” as described above occurs, the data transfer control section 105 judges whether or not to continue the transmission processing of the subsequent data packet 200 (S514). If the transmission processing is to be continued, the processing returns to S508 and the processings for the subsequent data packet 200 are repeated from S504 similarly to the above description. On the other hand, if the transmission processing is to be terminated, the processings for the subsequent data packet 200 are not performed and the magnetic apparatus 103 terminates the processings (S509).

In order that the judgment of continuation/termination of the transmission processing in above-described S514 is performed by the magnetic disk apparatus 103, there are prepared two commands of a first data read command and a second data read command as the above-described data read commands from the host apparatus 101. On an occasion of a data transfer request to the magnetic disk apparatus 103, the host apparatus 101 issues either the first or second data read command based on the termination judgment information 101a stored in a data storage part.

If the data read command issued from the host apparatus 101 is the first data read command, the termination judgment information indicating “continuation” is held in the setting register 105j of the magnetic disk apparatus 103 (see FIG. 3), while if the data read command is the second data read command, the termination judgment information indicating “termination” is held in the setting register 105j. In the magnetic disk apparatus 103, the judgment of S514 is performed based on the termination judgment information held in the setting register 105j. If the termination judgment information of the setting register 105j indicates “continuation”, the processing returns to S508, while if the termination judgment information indicates “termination”, the processings are terminated at S509.

It should be noted that as another method for notifying the magnetic disk apparatus 103 of the above-described termination judgment information, the host apparatus 101 can separately issue a command for setting including the termination judgment information just before issuing the data read command.

Further, as still another method for notifying the magnetic disk apparatus 103 of the above-described termination judgment information, a command for mode setting can be transmitted from the host apparatus 101 in advance before the above-described data read command. In the magnetic disk apparatus 103, the termination judgment information is stored in advance in the setting register 105j in correspondence with the command for mode setting. Hereby, an operation mode of the magnetic disk apparatus 103 is set in advance to be either of a mode of continuing the data transfer after the error occurrence or a mode of terminating the data transfer after the error occurrence. Therefore, the termination judgment information is not required to be set every time the data read command is issued.

For example, in a transfer of data (for example, music data and the like) in which a missing of one packet or so is allowable, valid data subsequent to invalid data can be transferred to the host apparatus 101 by the above-described termination judgment information being set to be “continuation”. In contrast, in a transfer of data in which a packet missing is not allowable, useless data transfer after the error occurrence can be omitted by the above-described termination judgment information being set to be “termination”. Incidentally, the above-described termination judgment information can be held in the RAM 105f instead of being held in the setting register 105j.

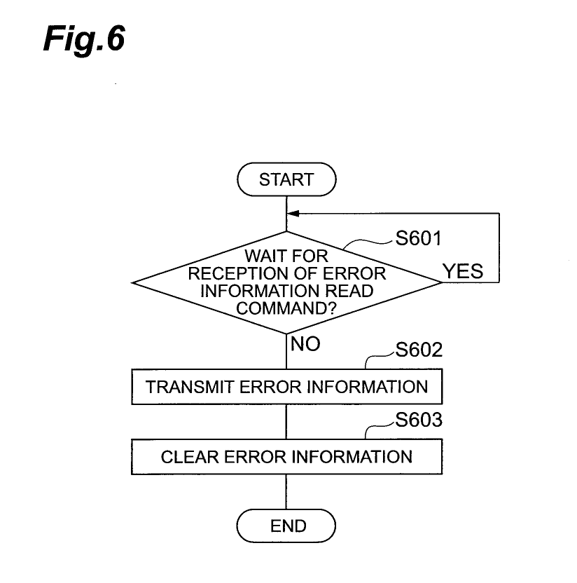

Subsequently, there will be described processings of the magnetic disk apparatus 103 in a case of receiving the error information read command from the host apparatus 101, with reference to FIG. 6 and FIG. 1.

When the magnetic disk apparatus 103 receives the command in a state of waiting for the error information read command (S601), the data transfer control section 105 transmits the error information stored in the error information portion 107 to the host apparatus 101 via the host interface control section 104 (S602). Then, the error information stored in the error information portion 107 is cleared (S603). If a defect at a data transfer time occurs, the host apparatus 101 can judge whether the defect is caused by the host bus 102 or by the magnetic disk apparatus 103 by referring to the above-described error information, a detail being described later.

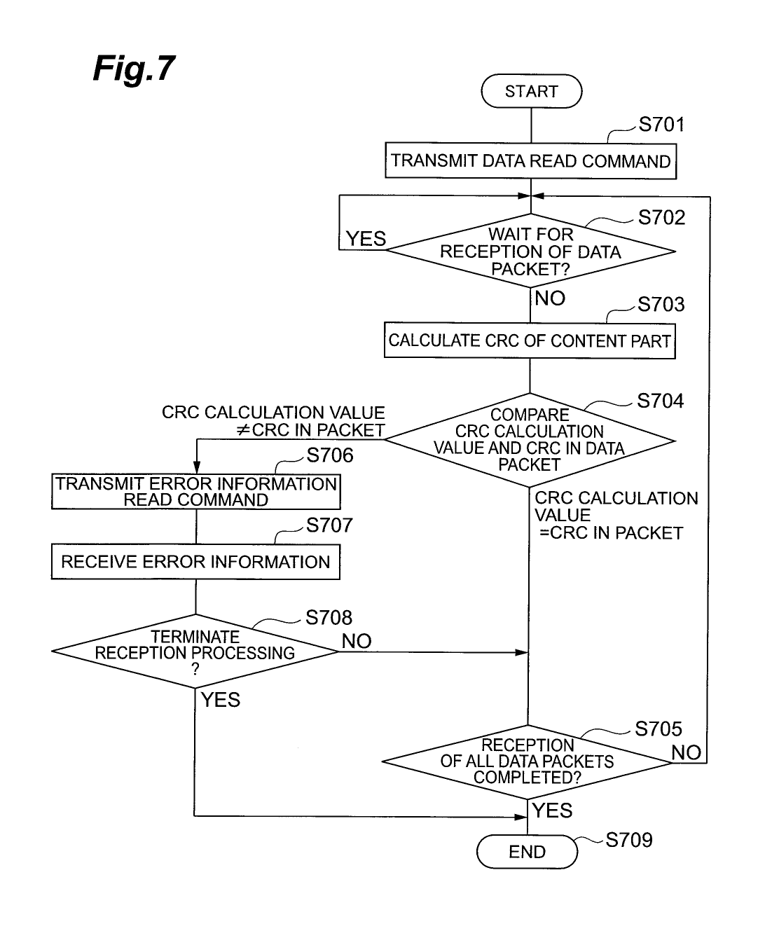

Subsequently, a command transmission control flow of the host apparatus 101 in the data transfer will be described with reference to FIG. 7 and FIG. 1.

First, the host apparatus 101 transmits the data read command including the data address and data length to be read to the magnetic disk apparatus 103 (S701). Then, the host apparatus 101 is brought into a reception waiting state of the data packet 200 to be received from the magnetic disk apparatus 103 (S702). In correspondence with the above-described data read command, a plurality of data packets (data groups) 200 are sequentially transmitted from the magnetic disk apparatus 103.

When the host apparatus 101 receives the above-described plural data packets 200, the host apparatus 101 sequentially performs following processings per data packet 200. First, the host apparatus 101 calculates the CRC value concerning the content data 202 of the data packet 200 based on a predetermined CRC calculation (S703).

Next, the host apparatus 101 compares the CRC calculation value and a value of the CRC data 203 actually stored in the data packet 200 (S704). If the above-described CRC calculation value coincides with (is equal to) the above-described CRC data 203, the host apparatus 101 accepts the content data of the data packet 200 as correct data. Then, the host apparatus 101 judges whether or not all the data packet equivalent to the data length included in the data read command are received (S705). If the judgment is Yes, the processings are terminated (S709), while if the judgment is No, the processings for the subsequent data packet 200 are repeated from S702.

On the other hand, in S704, if the CRC calculation value is not equal to the CRC data 203, the CRC error is detected as CRC mismatching. In this case, the host apparatus 101 can recognize that either of events occurs, a defect of some kind occurs on the host bus 102 in the data transfer or the data packet 200 with the mismatching CRC is intentionally created due to the occurrence of the reading error in the magnetic disk apparatus 103.

In this case, the host apparatus 101 refers to the error information of the magnetic disk apparatus 103 in order to judge which of the above-described events occurs. More specifically, the host apparatus 101 transmits the error information read command to read the error information from the magnetic disk apparatus 103 (S706). In correspondence with this command, the error information stored in the error information portion 107 is transmitted from the magnetic disk apparatus 103 as stated above, and the host apparatus 101 receives this error information (S707).

If information indicating the occurrence of the “reading error” is included in the received error information described above, the host apparatus 101 can judge that a cause of the above-described CRC mismatching is an intentional creation of the CRC mismatching packet by the magnetic disk apparatus 103. In this case, for example, the occurrence of the reading error due to the fact that the data already stored on the HDA unit 106 is destroyed by a cause of some kind is recognized in the magnetic disk apparatus 103, and the host apparatus 101 treats the data of the data packet 200 as invalid data.

Incidentally, by using a predetermined protocol (for example, an existing memory card protocol), it is possible to make the magnetic disk apparatus 103 perform the reception of the above-described error information read command during the processing of the data read command. Therefore, the host apparatus 101 can perform the above-described judgment of the cause of the CRC error instantly and quickly when the CRC error is detected.

On the other hand, if the information indicating the occurrence of the “reading error” is not included in the above-described error information received in S707, it can be judged that the cause of the above-described CRC mismatching is a defect on the host bus 102. In this case, the host apparatus 101 can stop the data transfer or perform a retry by issuing a command to stop the data transfer or a reset command, for example.

Next, if the host apparatus 101 detects the CRC error as described above, the host apparatus 101 judges whether or not to continue the reception processing of the subsequent data packet 200 (S708). This judgment of continuation/termination of the reception processing is performed based on the termination judgment information 101a stored in the data storage part. If the termination judgment information 101a indicates “continuation”, the processing returns to S705 and processings for the subsequent data packet 200 are repeated from S702 similarly to the above.

On the other hand, if the termination judgment information 101a indicates “termination”, the processings for the subsequent data packet 200 are not performed and the host apparatus 101 terminates the processings (S709). It should be noted that since the termination judgment information 101a is transmitted and stored also in the magnetic disk apparatus 103 as stated above, the same judgment is made about the above-described continuation/termination between the host apparatus 101 and the magnetic disk apparatus 103.

By the processings of the host apparatus 101 and the magnetic disk apparatus 103 as above, if the content reading error occurs in the magnetic disk apparatus 103, the data packet 200 with the mismatching CRC is intentionally created in the magnetic disk apparatus 103 and transmitted to the host apparatus 101. In the host apparatus 101 having received the data packet 200 with the mismatching CRC, the CRC error is detected and the error information existing in the error information portion 107 in the magnetic disk apparatus 103 is referred to.

If the host apparatus 101 can judge that the data packet 200 with the mismatching CRC is intentionally created by the above-described reference to the error information, the reading error occurring in the magnetic disk apparatus 103 can be detected. If it can be judged that the above-described data packet 200 with the mismatching CRC is not intentionally created, the defect on the host bus 102 can be detected as usual.

As stated above, it is possible to make the host apparatus 101 detect the reading error in the magnetic disk apparatus 103 by using the CRC inspection generally used for detection of the defect on the host bus 102. Therefore, according to this magnetic disk apparatus 103, it is possible to notify the host apparatus 101 of the occurrence of the reading error from the HDA unit 106.

In this case, it is not necessary to separately add a signal line for notifying the above-described reading error or it is not necessary to prescribe a new bus protocol. Since such a CRC inspection is generally used in the host apparatus 101 in order for the detection of the defect on the host bus 102, the magnetic disk apparatus 103 can be applied also to an existing host apparatus.

If the magnetic disk apparatus 103 transmits data as the plural data packets 200, since the above-described CRC inspection is performed sequentially per each data packet in the host apparatus 101, the reading error is detected during the transfer even if the transfer of all the data is not completed. Therefore, compared with a method in which the occurrence of the error is notified after the transfer of all the reading data ends, the occurrence of the reading error of the magnetic disk apparatus 103 can be notified to the host apparatus 101 soon, and as a result, control efficiency is enhanced.

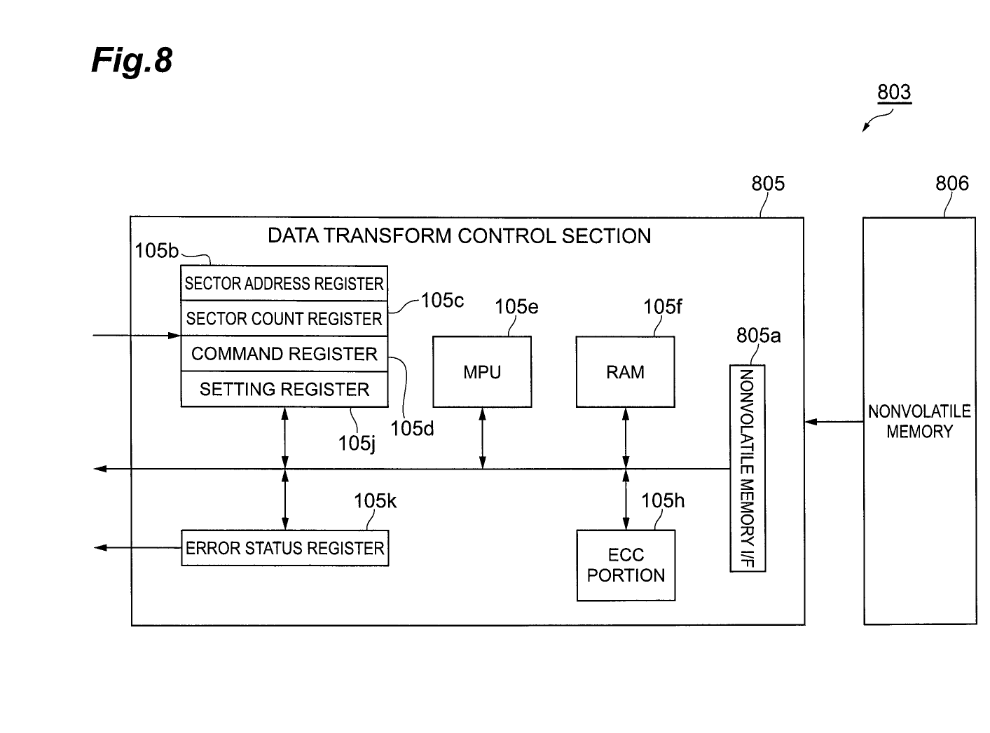

The invention is not limited to the aforementioned embodiment. Though the embodiment is applied to a magnetic disk apparatus in the above-described invention, a mode of a storage medium is not limited to the magnetic disk. For example, as shown in FIG. 8, it is possible to apply the invention to a storage apparatus 803 including a nonvolatile memory 806 as the storage medium. As examples of such a storage apparatus, there can be cited an MMC (Multi Media Card), an SD card, an SDIO card, a flash memory and other memory cards.

A data transfer control section 805 of the storage apparatus 803 has a nonvolatile memory I/F 805a corresponding to a nonvolatile memory instead of the read channel 105a of the data transfer control section 105. In the storage apparatus 803, the same symbol is applied to the same or equivalent configuration as that of the magnetic disk apparatus 103 and description thereof will be omitted. Further, though the content is described as a packet transmitted by 1-bit in the above embodiment, the content can be a transmission divided in parallel or in series to a plurality of bits.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage apparatus comprising:
a data transmission unit capable of transmitting data to a host apparatus in a data format in which a content to be transmitted to the host apparatus is accompanied by a CRC;
a storage medium in which the content is stored;
an error detection unit capable of detecting a reading error occurring in a processing in which the content is read from said storage medium;
an error information recording unit making the error information detected by said error detection unit be stored in an error information storage part; and
a CRC selection unit capable of selecting, based on the error information, whether to create a normal CRC or to intentionally create a mismatching CRC to make the host apparatus detect a CRC error in creating the CRC concerning the content.

2. The storage apparatus according to claim 1,
wherein said CRC selection unit selects creation of the mismatching CRC in a case that error information indicating an occurrence of the reading error is stored in the error information storage part and selects creation of the normal CRC in another case.

3. The storage apparatus according to claim 1,
capable of notifying the host apparatus of the error information stored in the error information storage part.

4. The storage apparatus according to claim 3,
wherein notification of the error information to the host apparatus is performed in correspondence with an error information read command issued at a time that the host apparatus detects the CRC error.

5. The storage apparatus according to claim 1,
capable, when the reading error is detected by said error detection unit for one data group of a plurality of data groups, of selecting whether or not to transfer remaining data groups subsequent to the data group to the host apparatus, in a case that the plurality of data groups are sequentially transferred to the host apparatus in correspondence with the data read command from the host apparatus.

6. The storage apparatus according to claim 5,
capable of selecting whether or not to transfer the remaining data groups to the host apparatus based on a type of the data read command.

7. The storage apparatus according to claim 5,
capable of selecting whether or not to transfer the remaining data groups to the host apparatus based on a command for setting having been received from the host apparatus in advance.

8. The storage apparatus according to claim 1,
wherein data transfer to/from the host apparatus is performed by a packet method.
